(19) United States
(12) Patent Application Publication
(10) Pub. No.: US 2005/0168189 A1
(43) Pub. Date: Aug. 4, 2005

(54) Power supply unit

(76) Inventor: Harald Schweigert, A-Wien (AT)

Correspondence Address: Siemens Corporation;Intellectual Property Department, 170 Wood Avenue South, Iselin, NJ, 08830, US

(21) Appl. No.: 10/513,591

(22) PCT Filed: Apr. 28, 2003
(86) PCT No.: PCT/AT03/00119

(30) Foreign Application Priority Data
May 14, 2002 (AT) A 737/2002

(51) Int. Cl. H02J 7/00

(52) U.S. Cl. 320/107

(57) ABSTRACT

A charger (LNT) for a battery-fed electrical/electronic device (HAN), with an electrically isolating transformer (TRA), which can be fed at its primary circuit and of which the secondary circuit features a converter/rectifier (GLR) to supply a charge voltage for the battery (AKU) of the device, where charger and device can be connected via a plug-in electrical interface (SSS), and. when the connection is established to the plug-in interface (SSS) a switch-on signal (sₑ) can be derived from the residual voltage of the battery (AKU), which can be forwarded via an isolating interface (ISS) from the secondary circuit (SES) to the primary circuit (PRS) to activate the charger (LNT).

### CROSS REFERENCE TO RELATED APPLICATIONS

This application is the US National Stage of International Application No. PCT/AT03/00119, filed Apr. 28, 2003 and claims the benefit thereof. The International Application claims the benefits of Austrian application No. 737/2002 filed May 14, 2002, both applications are incorporated by reference herein in their entirety.

### FIELD OF INVENTION

The invention relates to a charger for a electrical/electronic device powered by rechargeable batteries with an electrically isolating transformer, the primary circuit of which can be fed from an ac mains power circuit and the secondary circuit of which features a converter/rectifier to deliver a charge voltage for the battery of the device, where charger and device can be connected via a plug-in electrical interface.

### BACKGROUND OF INVENTION

This type of charger is known in many variants and is widely used, especially for mobile telephones, laptop and handheld computers, small household appliances etc.

The rechargeable battery of the device is connected via the plug-in interface to the charger which supplies the appropriate energy for the charge state of the device. A plurality of known circuits can also look after “intelligent charging”, depending on the rechargeable battery type, in which case a part of the charge electronics, e.g. voltage or temperature sensors, can be contained in the device, e.g. in a mobile phone. The separation of charger—device can thus be a fluid one and is not be seen as restrictive in any way.

Although known chargers consume only a small amount of power in idle mode, i.e. with no device connected, the total consumption of millions of such devices is anything but negligible, if one considers that each charger plugged into the ac mains has a power dissipation in idle mode in the order of magnitude of typically 0.2 to 2 Watts (for mobile telephones). This means that energy which could otherwise be used usefully elsewhere goes entirely to waste.

The overall problem is known and there have been attempts to provide a remedy. The simplest option, that of unplugging the charger from the mains when it is not needed, is hardly used because it is inconvenient or people forget to do it. Solutions which have become known reduce the dock frequency of switched-mode power supply of a charger if the charging power is removed or the charger is started up at regular intervals to test whether power needs to be supplied. Even in these cases, despite very costly electronics, the idle losses are still not always negligible.

A first consequence of the requirement for very low idle current losses is to avoid using 50 Hz mains transformers for chargers, since their magnetic losses cannot be reduced, and to use switched-mode power supplies with a transformer which makes possible the usual electrical isolation from mains power.

A switched-mode power supply embodied as a charger in accordance with the prior art is shown in FIG. 1. The ac mains voltage of, for example, 230 volts is rectified by means of a rectifier D1, here a diode, usually a diode bridge, to generate an intermediate circuit voltage to an intermediate circuit capacitor C1. This intermediate circuit voltage is applied with the aid of a switch S, e.g. a switching transistor controlled by an activation circuit AST, to the primary winding Wp of a transformer TRA, where in a known way a square wave pulse with a variable pulse duty factor is used.

The activation circuit AST is fed during operation via an auxiliary winding Wh and an auxiliary rectifier D3 of from a dc voltage which is present at a capacitor C2, and amounts to a few volts, e.g. 9 to 12 volts. Since this voltage is only present once the switched-mode power supply has started up, an auxiliary voltage is needed to start it which is derived from the high intermediate circuit voltage, e.g. 320 volts, via high-resistance series resistor R1 and a Zener diode D2. Since there is a voltage at series resistor R1 of the order of magnitude of 300 volts, the continuous losses that occur here, even when a current which is only within the mA range is flowing, are not negligible.

The primary current through the winding Wp is likewise measured in a known way at a low-resistance resistor R2 and this information is fed to activation circuit AST. On the secondary side the voltage of a secondary winding Ws is rectified by means of a rectifier GLR for a diode and is available at a capacitor C3 or at contacts of a plug-in interface SSS. The rechargeable battery AKV of an electrical/electronic device HAN, e.g. a mobile telephone, is to be charged with this voltage. Even though shown here for the sake of simplicity, the output voltage of the adapter LNT is usually not applied directly to the rechargeable battery to be charged, but via a switching transistor for example.

The voltage and/or the current at the output of the adapter LNT can be regulated in a known way. Here for example a signal relating to the output voltage is obtained from a control circuit URE and delivered via an optical isolator OKO electrically isolated to the activation circuit AST of the primary side.

JP 09007644 A discloses a battery part for a battery-operated device which delivers via a direct current/direct current converter a direct current for the device which is independent of the battery voltage. A battery voltage detector indicates at a separate output of the battery part the residual voltage or residual charge of the battery. This document does not provide any information about the charging of the battery.

In WO 98/38720 A a battery charging device with a low standby current is described, with the latter being achieved by the voltage of the battery to be charged being measured, especially compared with a reference value. On the basis of this a decision is made as to whether a charge circuit is activated or not.

DE 200 14 724 U discloses an adapter which uses SOHz technology with an in-phase regulator. Only when a load is connected is the adapter switched on. For this purpose a special 9V rechargeable battery is provided in the adapter. The object of this document is not the charging of this battery which serves as a support battery.

In the article by Bonekamp H., “Mains Adaptor Switch Improves Adaptor Efficiency”, Elektor Electronics, Elektor Publishers Ltd., Canterbury, GB, Vol. 25, No. 283, December 1999 (1999-12), Page 24-27, XP000924299, ISSN:0268-4519, a mains adapter is described that is likewise switched on or switched off depending on the voltage at its output, i.e. the voltage at the load. By contrast with the solution described above, a buffer capacitor is used here which can be charged up again and again. With no load this charging up occurs every two minutes for a short time, with the adapter idling in between.

EP 1 225 675 A1 describes a charger for a mobile unit, in which the charger is only switched on when the mobile unit is located in its cradle. This switch-on can be undertaken mechanically and/or electrically through current detection. No electrical isolation in the sense of an isolation interface is provided.

### SUMMARY OF INVENTION

One object of the invention now lies in creating a charger in which the idle losses are sharply reduced or completely eliminated.

This object is achieved with a charger of the type mentioned at the start, in which in accordance with the invention, on establishing the connection at the plug-in interface, a switch-on signal can be derived from the residual voltage of the battery which can be passed on via an isolating interface from the secondary circuit to the primary circuit for activating the charger.

The invention makes use of the fact that the battery to be charged in practice always features a residual voltage. Although this voltage may be far below the rated voltage and not be sufficient to operate the device, it is still large enough to generate a switch-on signal to activate the charger.

Since after disconnection of the plug-in interface the switched-mode power supply does not necessarily drop back into standby mode by itself, it can be useful for a switch-off pulse to be generated when the plug-in interface is disconnected.

With a simple-to-implement variant there is provision for the isolating interface to be formed by the winding of a relay and a relay contact.

Another useful variant and one that can at the same time be implemented at low cost makes provision for the isolation interface to be formed by an optical isolator link. In this case the light-generating element of the optical isolator is advantageously a light-emitting diode.

With a useful variant there is provision for the light-controlled element of the optical isolator link to be a photo TRIAC switch which forms an alternating current power switch in the primary circuit.

With another equally advantageous embodiment provision is made for the photosensitive element of the optical isolator link to be a photo transistor which is placed on the primary side as a switch or part of a switch between a power rectifier and an intermediate circuit.

Furthermore with another practical embodiment there is provision for a light-sensitive switch of the optical isolator link to be placed between the intermediate circuit and a primary activation circuit of the charger embodied as a switched-mode power supply.

A variant which is embodied differently as regards the isolating interface but is still useful provides for the isolating interface to be formed by a pulse transformer which is provided for transformation of a switch-on pulse generated at a primary activation circuit of the charger embodied as a switched-mode power supply. In this case it can be worthwhile for a primary activation circuit of the charger embodied as a switched-mode power supply to possess an electronic switch to which the switch-on pulse can be fed and for the switch-off pulse generated when the plug-in interface is disconnected to likewise be routable via the pulse transformer to the switch which toggles from its on state into its off state.

Another worthwhile variant is characterized in that an auxiliary matching transformer which features a transformer is provided, which, when the plug-in interface connection is established, is applied to the residual voltage of the accumulator and delivers a start power supply for a primary activation circuit of the charger embodied as a switched-mode power supply.

### BRIEF DESCRIPTION OF THE DRAWINGS

FIG. 1 shows a switched-mode power supply embodied as a charger in accordance with the prior art,

FIG. 2 shows a basic block diagram according to the invention,

FIG. 3 shows the basic circuit diagram of a first embodiment using an optical isolator link,

FIG. 4 shows the basic circuit diagram of an embodiment which uses a relay,

FIG. 5 shows the basic circuit diagram of a variant which uses an auxiliary matching transformer to create a switch-on signal.

FIG. 6 shows the basic circuit diagram of a variant which brings a switch-on pulse to the primary side via a pulse transformer,

FIG. 7 shows the basic circuit diagram of a second embodiment which uses an optical isolator link,

FIG. 8 shows the basic circuit diagram of a third embodiment which uses an optical isolator link and

FIG. 9 shows the circuit diagram of a simple embodiment using a power transformer and an optical isolator link.

### DETAILED DESCRIPTION OF INVENTION

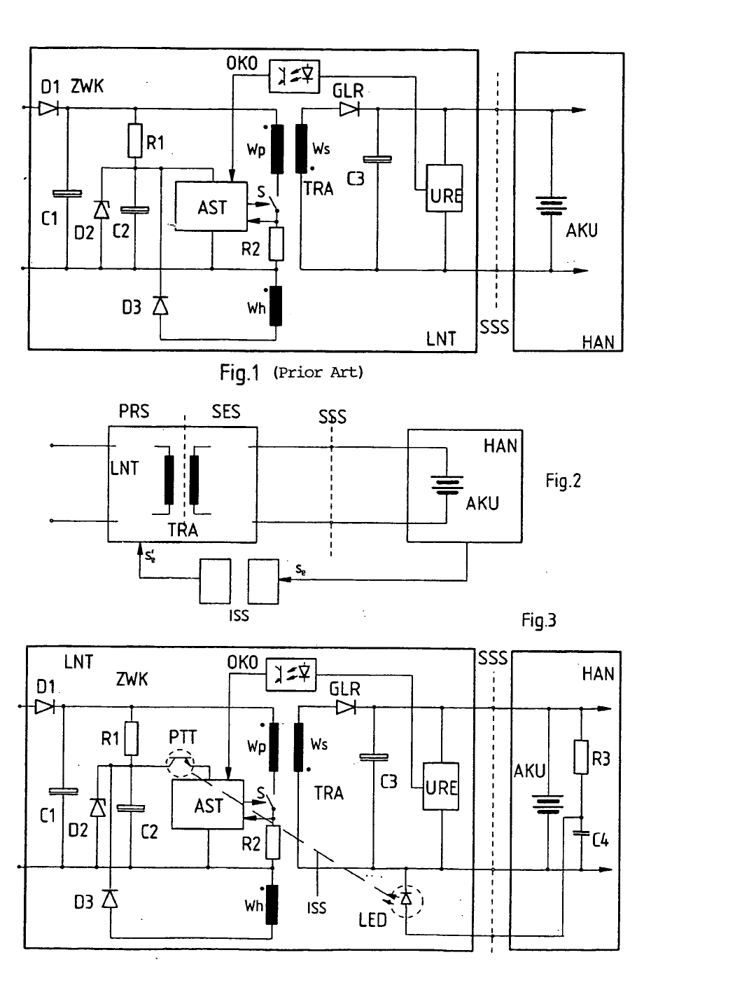

FIG. 2 shows a charger LNT which for example is embodied like the one shown in FIG. 1 as a switched-mode power supply and possesses a transformer TRA separating the primary side PRS lying on the power network from the secondary side SES. Via a plug-in interface SSS, e.g. a multipin interface usual with mobile telephones, the output voltage of the charger LNT is fed to the battery AKU of a device HAN. The invention now make provision, when the connection to the plug-in interface SSS is established e.g. plugging the charger connector into a mobile phone, for a switch-on signal Se to be derived or generated from the residual voltage of the battery AKU and forwarded via an isolating interface ISS from the secondary circuit SES as the primary switch-on signal sₑ′ to the primary circuit PRS in order to activate the charger LNT.

As is to be explained below on the basis of the exemplary embodiments in accordance with FIGS. 3 to 9, the switch-on signal Se can be a one-off pulse or a continuous signal and the electrically isolating interface can for example be embodied as an optical isolator, relay or transformer.

The embodiment according to FIG. 3 is based on a charger in accordance with FIG. 1 (prior art), but features the modifications listed below. At the plug-in interface SSS an additional contact is provided, via which the residual voltage of the battery AKU, in the present case the voltage at a capacitor C4, which is charged via resistor R3 from the battery AKU to its current voltage, on establishment of the connection to the plug-in interface SSS is applied to a light-emitting diode LED. This through connects a photo transistor PTT which lies between the power supply input of the activation circuit (AST) and the capacitor C2—cf. FIG. 1—via the optical isolating interface ISS, The resistor R1 is at such high-resistance that continuous operation of the activation circuit AST would not be possible, but the energy stored in the capacitor C2 is sufficient to start up the matching transformer. Power is then supplied to the activation circuit AST via the auxiliary winding Wh and the diode D3. The diode LED now remains activated and transistor PTT through-switched. When interface SSS is disconnected the standby state is re-established.

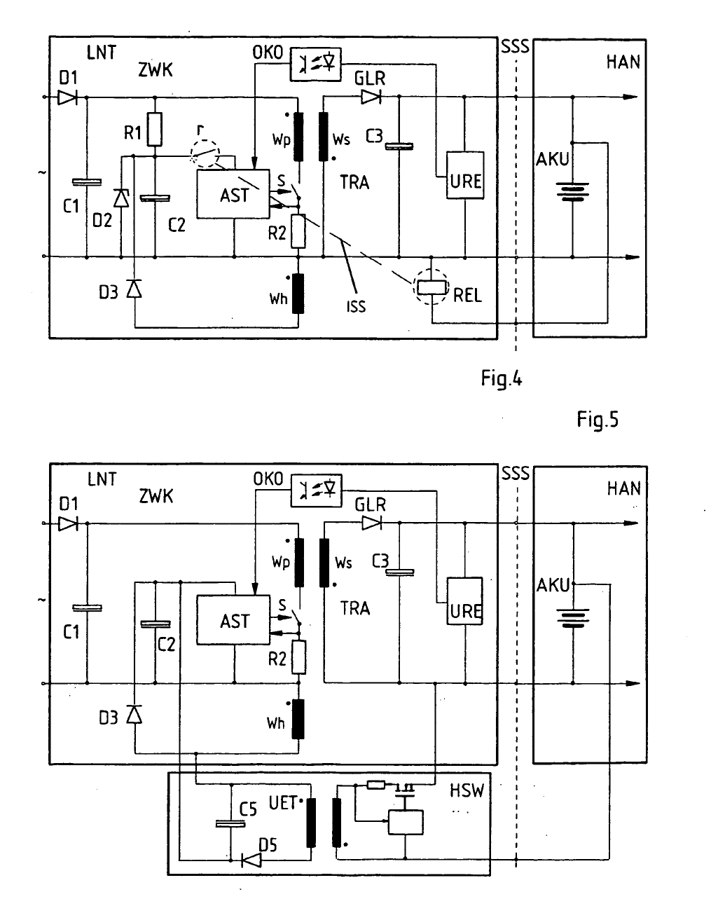

Another solution path is described for the circuit in accordance with FIG. 4, in which, by contrast to FIG. 3, the light-emitting diode LED is replaced by the winding REL of a relay and the transistor PTT by a working contact r of this relay REL,r. When a connection is established to the interface SSS the relay winding REL is applied to the (residual) voltage of the accumulator AKU, the relay picks up and the contact is closed.

Just as in FIG. 3 the activation circuit AST receives a voltage pulse which is sufficient for activation of a matching transformer. The relay REL,r then remains activated until the connection is released again at the interface SSS.

Another route is taken by the solution according to FIG. 5. Here the resistor R1 and the Zener diode D2 of FIGS. 3 and 4 are omitted so that on the primary side in standby mode no current flows at all. To allow the matching transformer to start up an auxiliary matching transformer HSW is provided, to which the voltage of the battery AKU is applied when a connection is established to the plug-in interface SSS with its input, which can be done directly—as here—or indirectly. The matching transformer HSW, e.g. an isolating transformer must include a transformer UET with electrically separated windings, otherwise it can be of any design, in which case dimensioning is only undertaken for short-term operation. The only circuit elements shown in this drawing which correspond to the prior art are a rectifier D5 and a capacitor C5, where the latter can also be omitted because of the capacitor C2 of the charger LNT.

The matching transformer HSW now supplies operating power at least during startup to the activation circuit (AST), where as an alternative the auxiliary power supply Wh, D3 of the charger LNT can also be omitted, but this should be taken into account when dimensioning the matching transformer HSW.

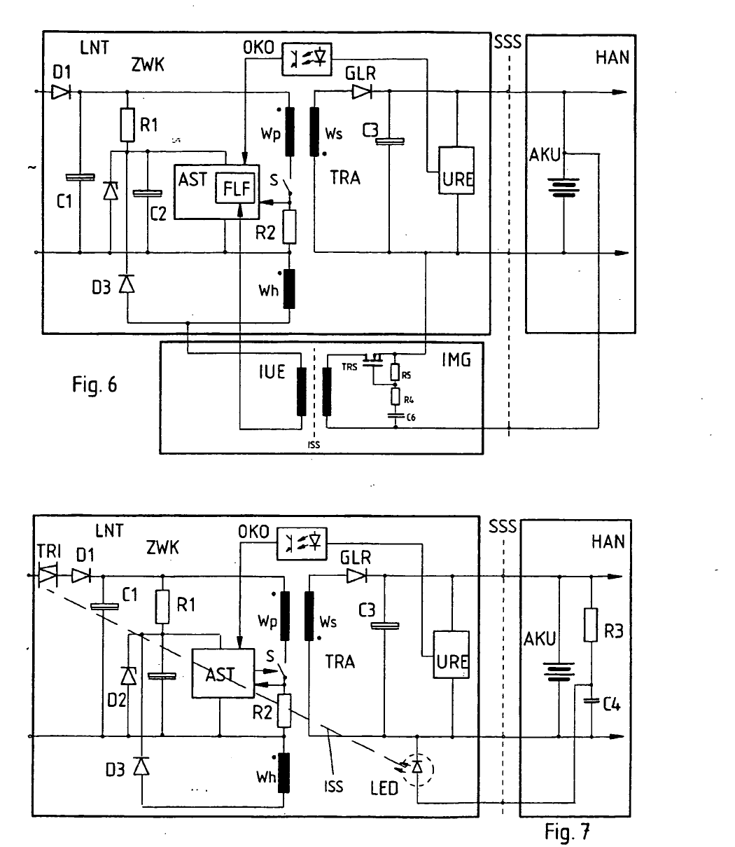

The variant in accordance with FIG. 6 is largely similar as regards the embodiment of the charger LNT to the embodiments shown in FIGS. 3 and 4. An electronic switch FLF, e.g. a flip-flop is provided here, that can be, but does not have to be, included in the activation circuit AST for example. Furthermore a pulse generator IMG is provided which has the task, when the connection is established at the interface SSS of creating a pulse and feeding it electrically isolated to the switch FLF, which looks after starting up the LNT, by for example applying the voltage present at the capacitor C2 to the electronics of the circuit AST. On disconnection of the interface SSS a further pulse is generated which changes the switch FLF back again and re-established the standby status.

The pulse generator IMG can for example be implemented in the way illustrated in FIG. 6, with one end of the primary winding of a pulse transformer IUE being able to applied via a contact of the interface SSS to the voltage of the battery AKU, whereas the other end of the winding is grounded via an FET transistor TRS. The gate of this transistor TRS is similarly connected via the series circuit of a resistor R4 and of a capacitor C6 to said contact of the interface and on the other side is grounded via a resistor RS. This circuit enables a pulse to be generated each time the charger LNI is plugged into or unplugged from the mobile phone and sent—electrically isolated—from the secondary winding of the pulse transformer IUE to the switch FLF.

The circuit variant according to FIG. 7 is largely constructed like that of FIG. 3. It differs in that the operating voltage input of the activation circuit AST is always connected to the plus pole of the capacitor C2 and not—as in FIG. 3—via a photo transistor. Instead a photo TRIAC switch TRI is connected as power between the rectifier D1 of the intermediate circuit ZWK and the alternating current network which forms the second element of the isolating interface ISS, i.e. here the optical isolator link LED-TRI. During operation diode LED emits a continuous signal, which keeps switch TRI closed until the interface SSS is released again. With this solution too no power is drawn from the mains in standby mode.

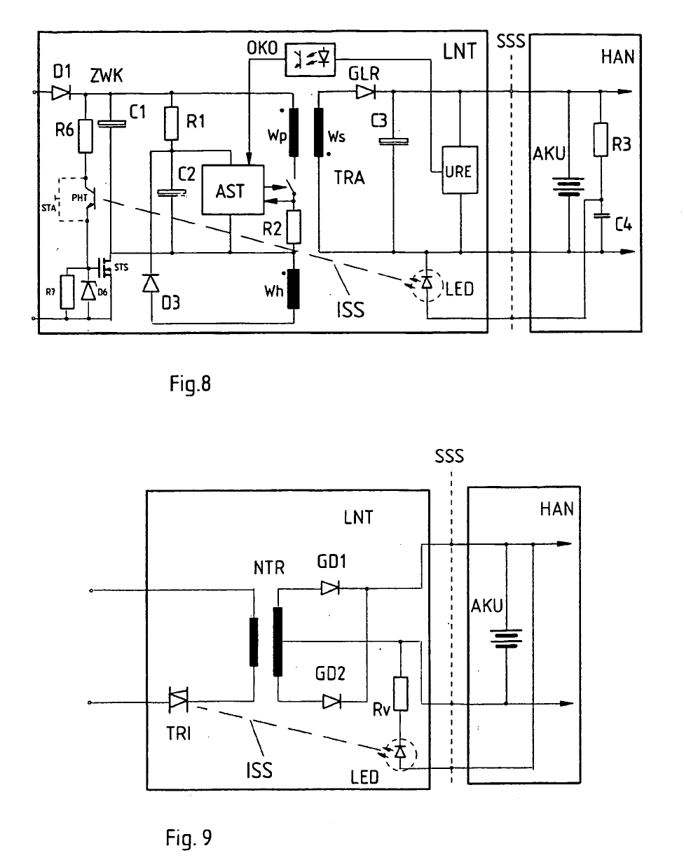

Another variant, but a similar one, is shown in FIG. 8. Here the second element of the optical isolator link is a photo transistor PHT which serves to activate the switching transistor STS. This transistor STS is located as a switch between the power rectifier D1 and the intermediate capacitor C1. The photo transistor PHT is located with its collector via a resistor R6 at the plus pole of the intermediate capacitor C1, with its emitter at the gate of switching transistor STS. The latter is grounded via a resistor R7 and—in parallel to this—a Zener diode D6. Here too it is ensured in standby mode that no power is consumed.

On the basis of FIG. 8—to represent all embodiments—the possible use of a start button STA is explained, which is shown as a dashed outline and lies in parallel to the photo transistor PHT and can bridge the latter if the residual voltage of the battery AKU for whatever reason is so small that no sufficiently large switch-on signal Se can be generated. In this case the user of the device and of the charger can initiate charging by briefly pressing the start button STA.

The embodiment according to FIG. 9 shows that the charger LNT does not necessarily have to be embodied as a switching adapter. Shown here is a power transformer NTR, of which the primary winding can be switched via a photo TRIAC switch TRI to the ac power network, whereas the charge voltage for the battery AKU of the mobile phone is obtained from the center-tapped secondary winding through rectification with two diodes GD1, GD2. Again, as shown in FIG. 7, a light-emitting diode LED can be operated via a contact of the plug-in interface SSS when the charger LNT is plugged into mobile HAN with a series resistor Rv which is located in the charger LNT. This makes the TRIAC switch TRI conductive and the charger LNT supplies power until the connection at the plug-in interface SSS is released. The embodiment in accordance with FIG. 9 makes clear that mains frequency transformers can usefully be employed by the invention to the extent that the losses are zero when the device is disconnected from the charger.

1-11. (canceled)

12. A charger for a battery-fed electrical/electronic device, comprising:
an electrically isolating transformer having a primary circuit for connecting the transformer to a power circuit and a secondary circuit including a converter/rectifier for supplying a charge voltage for a battery of the device, wherein
the charger and the device are connectable using an electrical plug-in interface, and wherein
the charger is adapted to generate a switch-on signal using a residual voltage of the battery and to forward switch-on signal from the secondary circuit to the primary circuit via an isolating interface for activating the charger.

13. The charger in accordance with claim 12, wherein a switch-off signal is generated when the plug-in interface is disconnected.

14. The charger in accordance with claim 12, wherein the isolating interface includes a winding of a relay and a relay contact.

15. The charger in accordance with claim 13, wherein the isolating interface includes a winding of a relay and a relay contact.

16. The charger in accordance with claim 12, wherein the isolating interface includes an optocoupler.

17. The charger in accordance with claim 13, wherein the isolating interface includes an optocoupler.

18. The charger in accordance with claim 16, wherein a light-generating element of the optocoupler is a light-emitting diode.

19. The charger in accordance with claim 16, wherein a photo-sensitive element of the optocoupler is a photo TRLAC switch forming an alternating current power switch in the primary circuit.

20. The charger in accordance with claim 18, wherein a photo-sensitive element of the optocoupler is a photo TRIAC switch forming an alternating current power switch in the primary circuit.

21. The charger in accordance with claim 16, wherein a photo-sensitive element of the optocoupler is a photo transistor located in the primary circuit forming a switch or part of a switch arranged between a power rectifier and an intermediate circuit.

22. The charger in accordance with claim 18, wherein a photo-sensitive element of the optocoupler is a photo transistor located in the primary circuit forming a switch or part of a switch arranged between a power rectifier and an intermediate circuit.

23. The charger in accordance with claim 16, wherein a photo-sensitive switch of the optocoupler is arranged between an intermediate circuit and a primary activation circuit of the charger, the charger embodied as a switched-mode power supply.

24. The charger in accordance with claim 18, wherein a photo-sensitive switch of the optocoupler is arranged between an intermediate circuit and a primary activation circuit of the charger, the charger embodied as a switched-mode power supply.

25. The charger in accordance with claim 12, wherein the isolating interface is formed by a pulse transformer for transmitting a switch-on pulse generated when plug-in interface connection is established at a primary activation circuit of the charger, the charger embodied as a switched-mode power supply.

26. The charger in accordance with claim 12, wherein the charger is a switched mode power supply and a primary activation circuit of the charger comprises an electronic switch switchable by a switch-on pulse and a switch-off pulse generated on disconnection of the plug-in interface, the pulses connected to the switch using a puls transformer.

27. The charger in accordance with claim 13, wherein the charger is a switched mode power supply and a primary activation circuit of the charger comprises an electronic switch switchable by a switch-on pulse and a switch-off pulse generated on disconnection of the plug-in interface, the pulses connected to the switch using a puls transformer.

28. The charger in accordance with claim 25, wherein the charger is a switched mode power supply and a primary activation circuit of the charger comprises an electronic switch switchable by a switch-on pulse and a switch-off pulse generated on disconnection of the plug-in interface, the pulses connected to the switch using a puls transformer.

29. The charger in accordance with claim 12, further comprising an auxiliary matching transformer having a transformer adapted to be connected to the residual voltage of the battery using the plug-in interface and to provide an initial supply voltage for a primary activation circuit of the charger, the charger embodied as a switched-mode power supply.

30. The charger in accordance with claim 12, wherein the switch-on signal is generated and forwarded when a connection is established to the plug-in interface.

31. A switched-mode power supply, comprising:
an electrically isolating transformer capable of being fed at its primary circuit from a power circuit, wherein a secondary circuit of the transformer having a converter/rectifier to supply a charge voltage for the battery of the device, wherein
the switched-mode power supply and the device are capable of being connected by an electrical plug-in interface, wherein
the switched-mode power supply is adapted to generate a switch-on signal using a residual voltage of the battery and to forward switch-on signal from the secondary circuit to the primary circuit via an isolating interface for activating the charger, wherein
the isolating interface is a optocoupler, and wherein
a photo-sensitive element of the optical isolator link is a photo TRIAC switch forming an alternating current power switch in the primary circuit.

32. A system, comprising:
a charger for a battery-fed electrical/electronic device, the charger comprising:
an electrically isolating transformer having a primary circuit for connecting the transformer to a power circuit and a secondary circuit including a converter/rectifier for supplying a charge voltage for a battery of the device, wherein
the charger and the device are connectable using an electrical plug-in interface, and wherein
the charger is adapted to generate a switch-on signal using a residual voltage of the battery and to forward switch-on signal from the secondary circuit to the primary circuit via an isolating interface for activating the charger; and
an electrical/electronic device having a battery and being connectable to the charger.
